(19) United States
(12) Patent Application Publication
(10) Pub. No.: US 2011/0135984 A1
(43) Pub. Date: Jun. 9, 2011

(54) Safety device for electric and hybrid electric vehicle energy storage systems

(76) Inventor: Jack A. Ekchian, Belmont, CA (US)

(21) Appl. No.: 12/928,235

(22) Filed: Dec. 4, 2010

Related U.S. Application Data
(60) Provisional application No. 61/283,652, filed on Dec. 4, 2009.

(51) Int. Cl. H01M 2/10; H01M 2/34; H01H 35/00

(52) U.S. Cl. 429/97; 200/61.04

(57) ABSTRACT

Danger of electrocution and fire from high voltage systems in electric and hybrid electric vehicles is mitigated by isolating high voltage electric power sources, of vehicles involved in accidents, in a sealed enclosure.

It involves the use of voltage disconnect devices to rapidly, manually or automatically disconnect and isolate the vehicle energy storage devices from the electrical system of the vehicle with ease and safety. The electrical power source may be a battery, a battery pack, a capacitor or other device which may be used to store electrical energy onboard a vehicle.

### CROSS REFERENCE TO RELATED APPLICATIONS

This application claims priority from provisional application Ser. No. 61/283,652 filed on Dec. 4, 2009, the entire contents of which is hereby incorporated by reference.

### BACKGROUND

1. Field of Invention

This invention pertains to electric vehicles (EVs) and hybrid electric vehicles (HEVs) and more particularly to the improved safety of electrical systems used in such vehicles.

2. Description of Prior Art

During the past decade, there has been renewed interest in EVs and HEVs. These vehicles offer significant improvement in fuel economy and emissions. The electrical systems of such vehicles typically operate at voltages of 40 volts DC or more which is significantly higher than the conventional 12 volt automotive systems. Such vehicles utilize high voltage battery packs to store significantly greater amounts of electrical energy onboard the vehicle than is the case in conventional vehicles today. These battery packs are usually comprised of multiple sub-groupings of cells or batteries of lower capacity that are connected in series or in parallel to achieve the desired voltage and amperage capacity at the output terminals of the battery pack. Unfortunately, the high voltages that are used in such vehicles pose significant hazards, including danger of electrocution or increased risk of fire. Certain occurrences, such as an accident where various components in an EV or HEV may be damaged, crushed or dislodged or where the vehicle becomes partially or wholly immersed in water, exacerbate these dangers for vehicle occupants, rescue personnel or others who may need to come into contact with such vehicles.

Also, it typically takes an extended amount of time to recharge the battery pack of an EV. This limits its effective driving range because of the maximum amount of energy that can be typically stored onboard such a vehicle at any given time. One solution that has been considered is the establishment of swap stations at convenient locations where partially or fully discharged battery packs can be swapped with pre-charged units. One of the key drawbacks of this approach is that during the swapping process, the exposed terminals of a charged battery pack can pose added risk of electrocution or other injury to personnel performing the swap.

### SUMMARY OF INVENTION

One object of the present invention is to provide a method and apparatus for improving the safety of high voltage vehicular electrical systems especially during and after accidents and in case of immersion in water. Although the present invention is especially suited to EVs and HEVs, it may be utilized with electrical systems where the voltage is high enough to be hazardous.

These and other objects, advantages and features of the present invention are achieved, according to one embodiment, by placing an electrical disconnect mechanism (EDM) between the electric storage device (ESD) and at least a portion of the electrical system of a vehicle such that when the EDM is activated, that portion of the electrical system is disconnected from the ESD. It is preferable that at least one EDM be located such that when it is activated, the entire electrical system of the vehicle is disconnected from the ESD. The ESD may be comprised of, for example, a battery, a battery pack, a capacitor, flywheel or other device which may be used to store electrical energy onboard a vehicle. The EDM may be, for example, an automatic circuit breaker, an electrical relay or a manual switch.

It is preferable that an EDM is activated automatically in the event of, for example, an accident or immersion in water. An EDM may be activated by sensors such as accelerometers, inclinometers, water detectors, pressure sensors, and temperature sensors. The EDM may also be activated by sensors that detect airbag deployment.

A manual disconnect switch may also be used to trigger an EDM. Manual switches may be located at various locations in the vehicle such as the passenger compartment or in close proximity to the ESD. Remote manual switches may also be used to activate an EDM remotely. For this purpose, a special button may be incorporated with the remote door opener which activates a switch located in the vehicle.

In accordance with the invention, an ESD may be partially encased in a protective enclosure that may include one or more EDMs. It is preferred that the ESD be completely enclosed although only certain terminals of the ESD may be encased. The enclosed electrical storage unit (EESU) would preferably have at least one positive and one negative external terminal. Each such terminal would be connected to the corresponding terminal of an ESD within the enclosure. The external terminals of an EESU would be used to connect to the electrical system of the vehicle. Intervening EDMs within the EESU may be used to disconnect one or more of its external terminals from the ESD terminals. It is preferable that the EESU be made waterproof. It is further preferred that the enclosure of the EESU be made of insulating material. If the enclosure is manufactured of conductive material, it is preferred that at least its internal surface be coated with an insulating material. It is further preferred that the enclosure materials or the coating materials be resistant to caustic substances such as battery acid.

Sensors may be used to detect the presence of water at various locations in the vehicle. These sensors may trigger one or more EDMs within the EESU so that the external terminals are deactivated and the risk of electrocution is minimized.

It is a further object of the present invention to provide a method and apparatus for easily and safely removing a high voltage EESU from a vehicle and replacing it with a fully charged unit without exposing personnel performing the task to risk of injury.

In accordance with the invention, an EESU may be designed to be easily and safely removed from the vehicle and swapped with another unit. The EESU may include, on its exterior, one or more proximity or other switches that are automatically tripped when the EESU is removed. These switches would trigger one or more EDMs in the EESU. As a result, the external terminals of the EESU may then be automatically disabled during the removal process. The terminals may be reactivated when an EESU is reinstalled in the vehicle.

Automatic activation of EDMs may occur, for example, as a result of unexpected events such as an accidental crash or immersion in water. Automatic activation of the EDM may also occur when certain hazardous operations are performed such as the withdrawal of a fully or partially charged removable EESU from the vehicle.

One or more EDMs may also be activated manually under various conditions. Mechanics, emergency personnel or others who need to work on the vehicle may activate EDMs prior to starting work on the vehicle. An EDM may be activated from the passenger compartment, other location in the vehicle, or from a remote position.

The EDMs may be completely mechanical, electrical, or may comprise a combination of electrical and mechanical components. An EDM may be activated manually by electrical or mechanical switches that are in close proximity or remote from it. The switches may be connected to an EDM electrically or mechanically by, for example, various linkages or gears. An EDM may be triggered by means of sensors connected directly to it or through an intervening controller. Sensors may also communicate with an EDM or controller by such methods as acoustic, radio or other electromagnetic transmission.

It is a further object of the present invention to use an auxiliary circuit breaker switch that triggers the EDM as a result of current in an auxiliary branch of the circuit. Such a circuit breaker switch may interrupt a main circuit branch because high current is present in the auxiliary circuit branch.

It is a further object of the present invention to use an EDM to disconnect an ESD as an antitheft measure. The switch would be used to trip at least one EDM so that the ESD is disconnected from at least a portion of the electrical system of the vehicle. The switch could then be used to reconnect the ESD. A code protected switch may be used for this purpose.

### BRIEF DESCRIPTION OF THE DRAWINGS

FIG. 1 illustrates an EESU configured according to an embodiment of the invention which comprises an enclosure, which comprises an ESD, and an EDM which communicates with several sensors.

FIG. 2 is a schematic drawing of an ESD that may be employed in the embodiment in FIG. 1.

FIG. 3 illustrates an EESU configured according to another embodiment of the invention which comprises an enclosure which encases a terminal of an ESD and an EDM.

FIG. 4 illustrates an EESU configured according to another embodiment of the invention which comprises an enclosure which encases one terminal of an ESD and an EDM. A remote water sensor is connected directly to the EDM which is an auxiliary circuit breaker.

FIG. 5 illustrates another ESD, comprising a battery pack, for use in an EESU configured according to an embodiment of the invention. The batteries in the battery pack are connected in parallel.

FIG. 6 illustrates another ESD, comprising a battery pack, for use in an EESU configured according to an embodiment of the invention. It includes switches or relays that may be used to connect the individual subunits of the ESD in a series configuration or to electrically separate individual subunits. The subunits may be, for example, batteries or individual cells.

FIG. 7 illustrates an EESU configured according to another embodiment of the invention wherein a removable enclosure comprises an ESD, an EDM and a switch which is mounted on its exterior surface. Cover of enclosure is not shown.

FIG. 8 illustrates an EESU configured according to another embodiment of the invention which comprises intake and exhaust cooling ports. Cover of enclosure is not shown.

FIG. 9a illustrates an un-tripped auxiliary circuit breaker configured to operate as an EDM according to another embodiment of the invention. FIG. 9b illustrates the EDM in FIG. 9a in a tripped state.

FIG. 10 illustrates an EESU configured according to another embodiment of the invention comprising the EDM in FIG. 9a.

### DETAILED DESCRIPTION OF THE INVENTION

Descriptions of figures and embodiments that follow are intended to be illustrative and exemplary and are not intended to limit the invention.

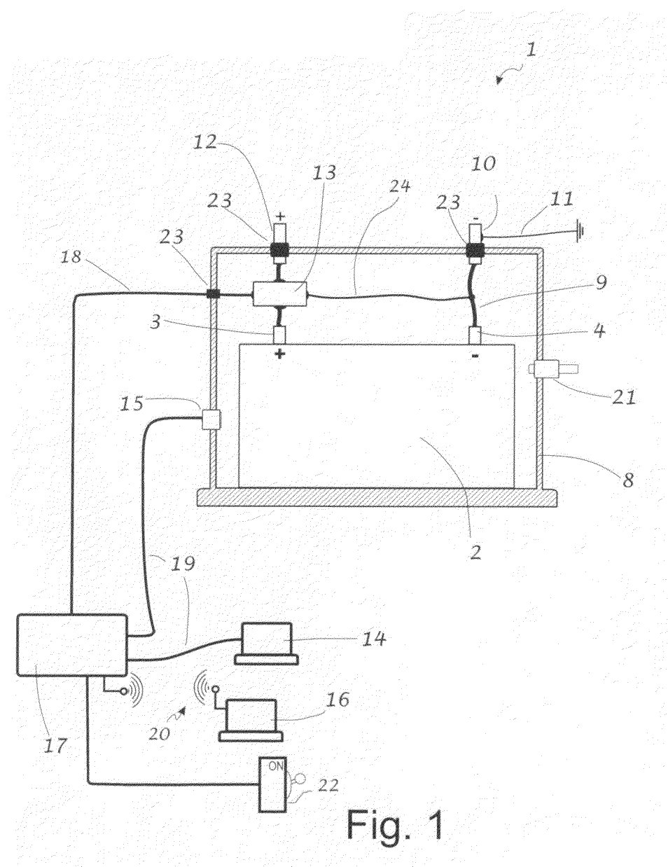

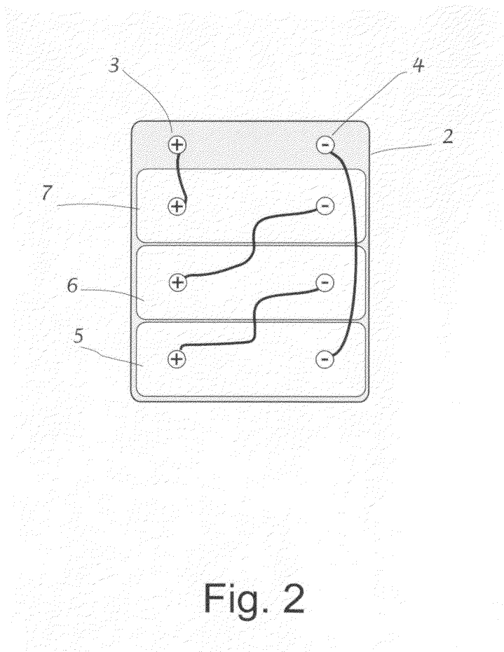

FIG. 1 is a schematic of an EESU 1 which comprises an ESD 2 with positive 3 and negative 4 terminals. The EESU has external terminals 10 and 12 which may be used to deliver electrical power to various vehicle systems and to return energy to the ESD for storage. In FIG. 1, the ESD 2 is comprised of one or more batteries that are connected to produce the desired voltage and current capacity across the terminals 3 and 4. FIG. 2 shows such a battery pack comprised of three subunits 5, 6, and 7 which are connected in series. The subunits in the ESD may be, for example, batteries or individual cells. Also shown are the positive 3 and negative 4 terminals of the ESD. The ESD in FIG. 1 is surrounded by a protective enclosure 8. This enclosure is preferably waterproof and insulating.

In the FIG. 1 embodiment, the negative terminal 4 is connected by lead 9 to the EESU negative terminal 10 which may be grounded by lead 11. Positive terminal 3 is connected to external positive terminal 12 with an intervening EDM 13. When the EDM is triggered, the link between terminal 3 and terminal 12 is broken and the battery pack is effectively isolated within the enclosure 8 and the EESU is disabled and the ESD isolated.

The EDM may be triggered automatically by sensors such as 14, 15, and 16. A controller 17 may be used to monitor the output from sensors and to control the operation of one or more EDMS. The communication between the controller 17 and the sensors occurs through leads 19 and the transmission link 20 which may utilize, for example, acoustic or electromagnetic signals. The EDM may also be grounded by means of leads 9, 11 and 24. Sensors for triggering an EDM may be located within the ESU enclosure (not shown), attached to the enclosure (sensor 15) or remote from the enclosure, such as sensors 14 and 16. Sensors 14 and 16 may be, for example, accelerometers or water sensors that detect the presence of water. Sensor 15 may be, for example, a pressure transducer. To avoid excessive pressure build-up in the enclosure, relief valve 21 may be used to equalize pressure with the surroundings. The EDM may also be triggered by a manual switch 22 which may communicate with the EDM directly or through controller 17.

In the embodiment in FIG. 1, the internal terminal 3 may be automatically disconnected from external terminal 12 when certain conditions occur, such as a crash or immersion of the vehicle in water. Manual switches may also be used for the same purpose by people such as the vehicle operator, a mechanic or emergency personnel.

It may also be necessary to seal penetrations through the walls of the enclosure with seals 23 to keep the enclosure waterproof. The enclosure may be kept permanently waterproof or be made waterproof when the presence of water is detected at certain locations in an EV or HEV. With a waterproof enclosure, an EDM may be used to deactivate one or more external terminals of the EESU and mitigate the possibility of electrocution, injury or fire.

Alternatively, one or more EDMs may be used in an EESU to disconnect both positive and negative terminals of the battery pack. As another alternative, in situations where the positive terminal 12 is grounded, the EDM may be used to disconnect only the negative terminal. Alternatively, the controller 17 may be located within the enclosure 8 or combined with an EDM in a single unit.

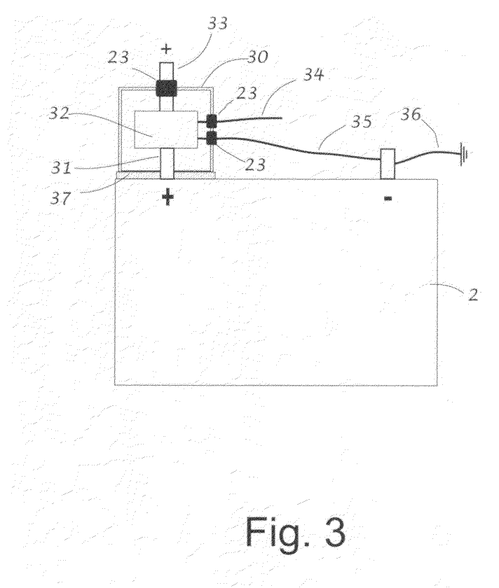

FIG. 3, which illustrates another embodiment of the invention, shows an EESU where a protective enclosure 30 is used to enclose one terminal 31 of the ESD 2. Before the EDM is activated, terminals 31 and 33 are electrically connected. When the EDM is activated or tripped, it causes terminals 31 and 33 to become separated such that EESU terminal 33 is electrically isolated from the ESD terminal 31. The EDM may be connected to external sensors by means of lead 34 and ground by means of leads 35 and 36. The enclosure is preferably sealed so that water cannot reach terminal 31 inside the enclosure in the event that the enclosure is submerged. Seals 23 and 37 may be necessary at various locations in order to maintain a waterproof enclosure 30. It is further preferred that the enclosure 30 is made of an insulating material

Alternatively, the protective enclosure 30 can be used to encase and isolate a positive and a negative terminal of the ESD without enclosing the entire ESD.

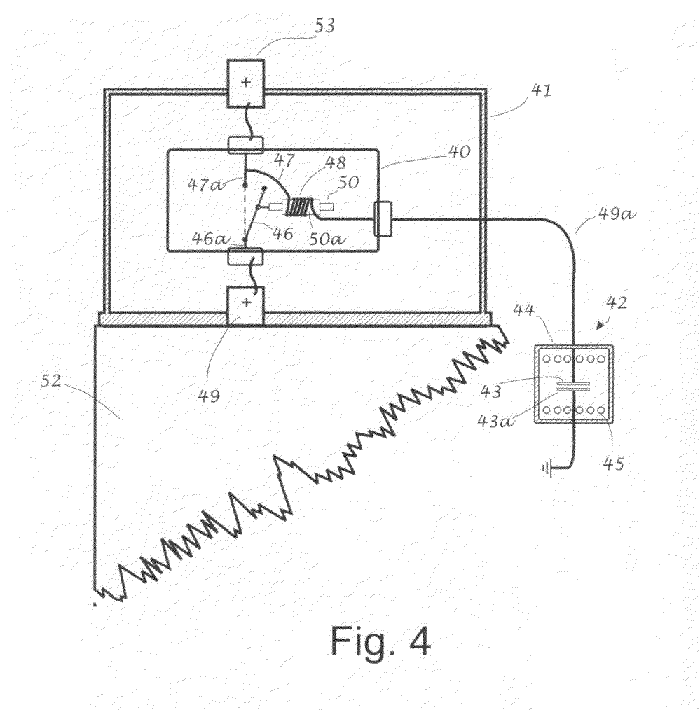

Referring to FIG. 4, the schematic illustrates an embodiment of an EESU according to the invention comprising an EDM 40 in an enclosure 41 that encases an ESD terminal 49. In this embodiment, the external water sensor 42 comprises two conductive plates 43, 43a, preferably metallic. The sensor housing is perforated with holes 45 which could permit water to enter the sensor and cover the plates 43 and 43a. While switch 46 is in the closed position (shown by the dashed line), and the sensor 42 is submerged, current will flow through lead 47, coil 48, lead 48a, and plates 43, 43a to ground. The current flowing through coil 48 will establish a magnetic field that will move plunger 50 axially within core 50a and open switch 46. Internal terminal 49 of battery pack 52 (shown segmented) will therefore be electrically disconnected from the EESU terminal 53. The water detectors may be placed in various convenient locations in the vehicle. Multiple sensors could be used. Alternatively, in sensor 42, plate 43a may be connected to the negative terminal of the ESD. Switch 46 may also be spring loaded so that once opened, it will remain open till it is reset manually. EDM 40 in FIG. 4 is an auxiliary circuit breaker that interrupts electrical flow through one branch of the EDM circuit, comprising leads 46a and 47a and switch 46, using the voltage in that branch to establish a current in an auxiliary branch, comprising leads 47, 48a and coil 48 and sensor 42.

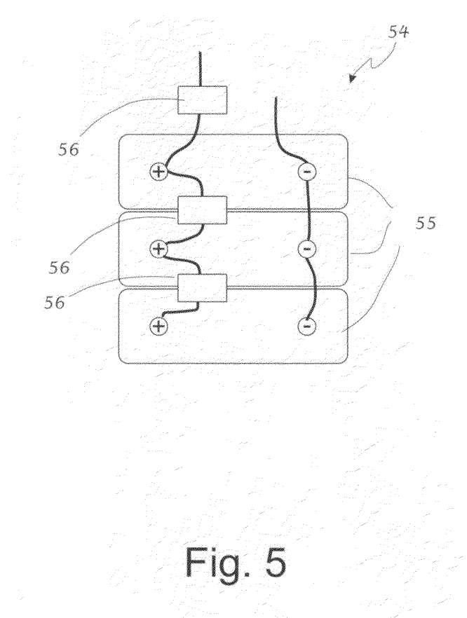

FIG. 5 shows an ESD 54, comprising three batteries or cells 55 connected in parallel. In this embodiment, the configuration of the ESD may be modified by using one or more intermediate EDMs 56 to disconnect and isolate individual batteries or cells in the EDM.

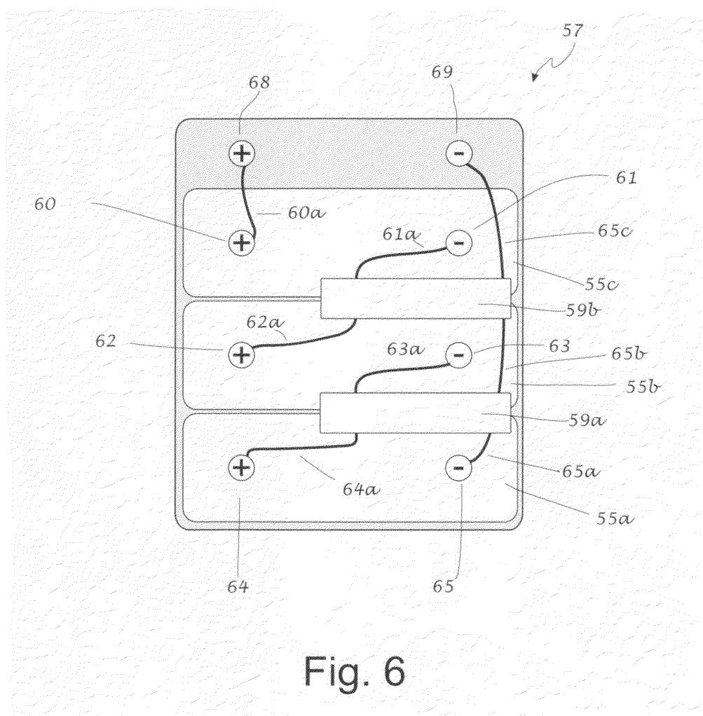

FIG. 6 illustrates an EDM 57 comprised of three batteries 55a, 55b and 55c connected in series with intermediate EDMs 59a and 59b that can be used to disconnect individual sub-components of the battery pack. Terminals 68 and 69 are the terminals of the EDM 57.

In the ESD in FIG. 6, batteries 55a, 55b and 55c may be connected in series by using EDM 59a to connect lead 65a to lead 65b and lead 64a to lead 63a, while EDM 59b is used to connect lead 65b to lead 65c and lead 62a to lead 61a.

Alternatively, EDM 59b may be used to disconnect lead 62a from lead 61a and lead 65b from 65c while connecting 61a to 65c. In this case, the voltage at terminals 68 and 69 will be equivalent to the voltage of battery 55c.

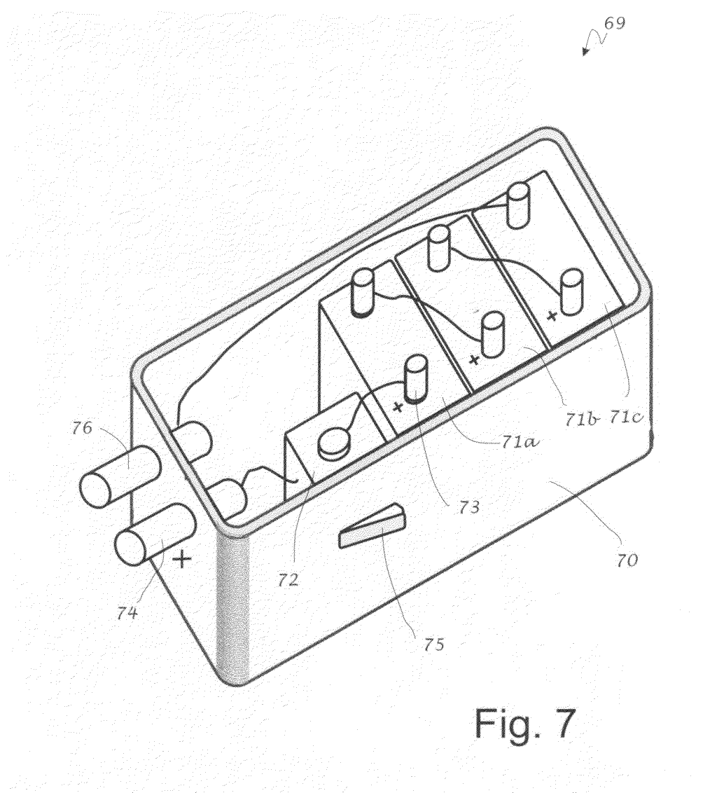

FIG. 7 illustrates a removable EESU 69 with enclosure 70 (enclosure cover not shown). The ESD is a battery pack which comprises three batteries 71a, 71b and 71c, an EDM 72 between the positive terminal of the battery pack 73 and the positive terminal of the EESU 74. The EDM is triggered by a mechanical switch 75. When the switch is released, the EDM disconnects terminal 73 from terminal 74 disabling the EESU and isolating the ESD. When the EESU is placed in the vehicle, terminals 74 and 76 engage corresponding positive and negative terminals in the vehicle electrical system (not shown). A properly located protrusion (not shown) in the vehicle is used to engage and depress switch 75 when the EESU is placed in its receptacle in the vehicle. When the switch 75 is depressed, terminals 73 and 74 are reconnected and the EESU is reactivated.

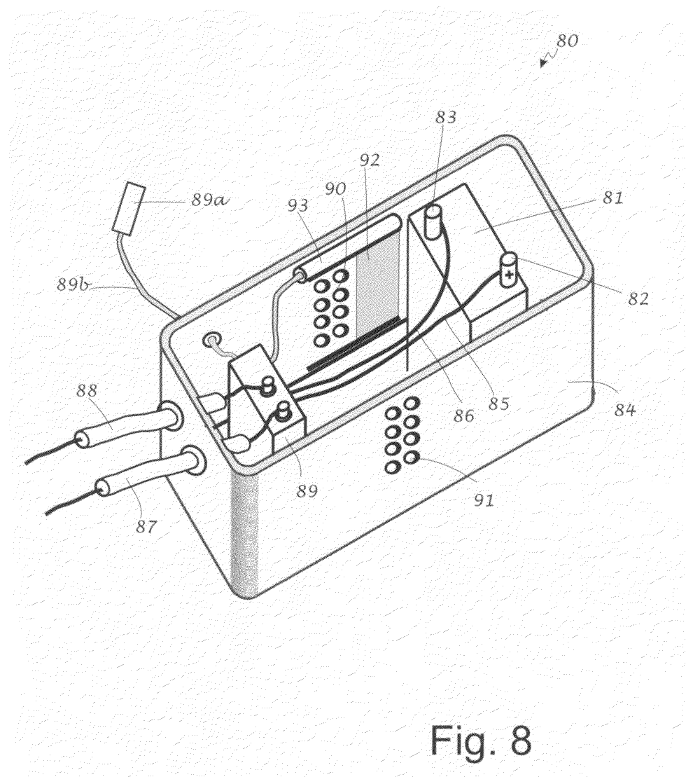

FIG. 8 shows an embodiment of the invention comprising an EESU 80. The EESU comprises a battery pack 81 with a positive terminal 82 and a negative terminal 83 in a sealable enclosure 84 which has a watertight cover (not shown). The terminals of the battery pack are connected to positive cable 85 and negative cable 86. External supply cables 87 and 88 are used to supply electrical energy to the vehicle system from the battery pack or to obtain electrical energy from the vehicle system and supply it to the battery pack for storage. An intervening combination EDM and controller 89 is configured to disconnect cables 85 and 86 from external supply cables 87 and 88 respectively. The EDM is activated by means of a sensor 89a which is connected to the combination EDM controller unit by cable 89b. The enclosure also comprises intake ports 90 and exhaust ports 91 for circulating cooling air into and out of the enclosure. Intake port cover 92 is used to close intake ports 90. An exhaust port cover (not shown) is used to seal exhaust ports 91. Circulation of air through the ports 90 and 91 may be used to remove heat generated during the charging and discharging of the battery pack 81.

Intake port cover 92 is moved into position by actuator 93. Actuator 93 which may be, for example, a linear motor or a screw mechanism, is activated by command from the controller in response to input from sensor 89a. Actuator for exhaust port cover is not shown. When the intake and exhaust ports are covered, the enclosure becomes waterproof.

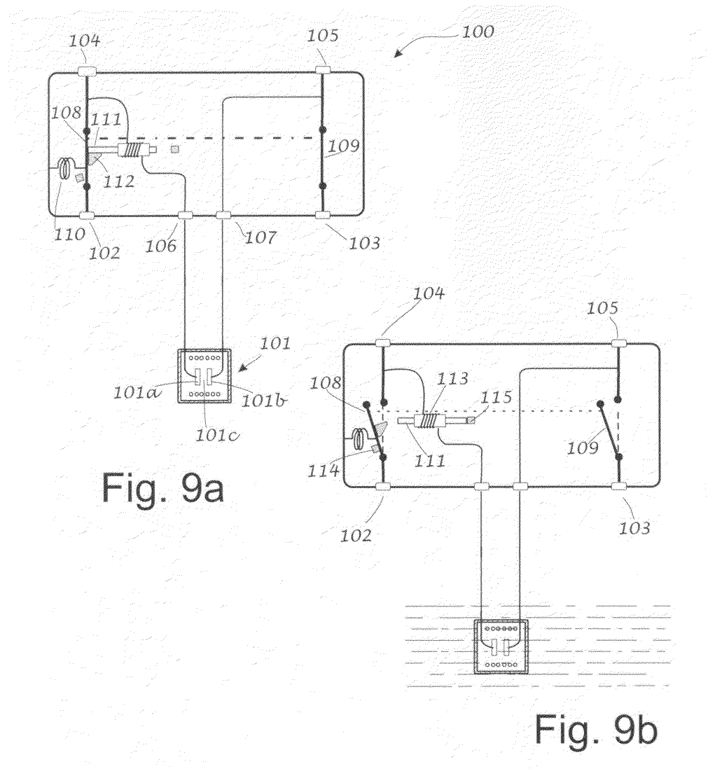

FIG. 9a is a schematic of a two pole un-tripped auxiliary circuit breaker 100 connected to a water sensor 101. Sensor is comprised of plates 101a and 101b with an intervening gap 101c. When the gap is filled with air, the sensor acts as an open switch. When untripped, the circuit breaker transfers voltage supplied to its input terminals 102 and 103 to its output terminals 104 and 105 respectively.

Water sensor is connected to sensor terminals 106 and 107. Switch 108 connects terminals 102 and 103 and switch 109 connects terminals 103 and 105. In the embodiment in FIG. 9a, switches 108 and 109 are ganged together and loaded by spring 110 to open automatically when plunger 111 is withdrawn so it no longer engages triangular stop 112 attached to switch 108.

FIG. 9b illustrates the auxiliary circuit breaker shown in FIG. 9a, where the sensor 101 has been submerged and gap 101c is filled with water which allows current to flow through the sensor. Current flowing through the sensor will also flow through the coil 113 which will establish a magnetic field that causes plunger 111 to be withdrawn and allows switches 108 and 109 to open. FIG. 9b illustrates that when the auxiliary circuit breaker is tripped, input terminals 102 and 103 are disconnected from output terminals 104 and 105 respectively. Stops 114 and 115 limit the motion of the switches 108 and 109 and plunger 111 respectively.

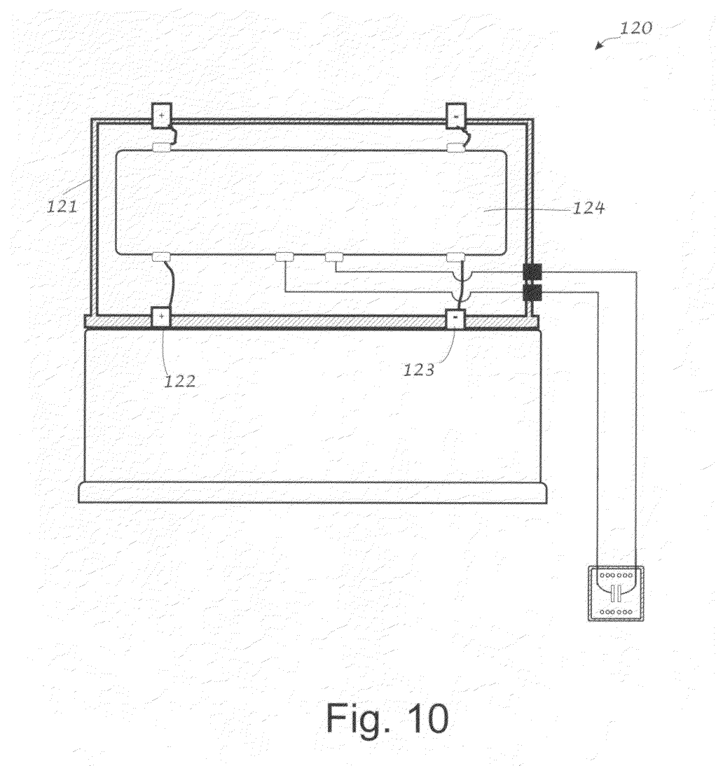

FIG. 10 illustrates an embodiment of the invention comprising an EESU 120 comprising enclosure 121 that encases ESD terminals 122 and 123 and auxiliary circuit breaker 124. The enclosure and ESD are preferably waterproof. When the auxiliary circuit breaker is tripped, the EESU terminals are deactivated and the ESD terminals 122 and 123 are isolated.

The invention has been described in terms of its functional principles and several illustrative embodiments. Many variants of these embodiments will be obvious to those of skill in the art based on these descriptions. Therefore, it should be understood that the ensuing claims are intended to cover all changes and modifications of the illustrative embodiments that fall within the literal scope of the claims and all equivalents thereof.

What is claimed is:

1. An apparatus of electrical power storage, the apparatus comprising:
an enclosure which comprises a battery pack and an electrical disconnect mechanism external to the enclosure which is connected to a water sensor
said battery pack having a terminal for supplying electrical energy to the battery pack and receiving electrical power from the battery pack and
said enclosure having an electrical contact on the exterior of the enclosure which is electrically conductively connected to said battery pack terminal
said electrical disconnect mechanism configured to electrically disconnect the terminal from the external electrical contact when water is detected by the water sensor.

2. An electrical power storage unit according to claim 1 wherein the enclosure is made primarily of nonconductive material.

3. An electrical power storage unit according to claim 2 wherein the enclosure is made primarily of a material that is resistant to caustic substances.

4. An electrical power storage unit according to claim 3 wherein the enclosure is made primarily of a material that is resistant to battery acids.

5. An electrical power storage unit according to claim 1 wherein the enclosure is sealed.

6. An electrical power storage unit according to claim 1 wherein the enclosure further comprises an intake and an exhaust port for the flow of cooling air.

7. An electrical power storage unit according to claim 6 wherein the enclosure further comprises a mechanism for automatically sealing said intake and said exhaust port when water is detected by said water sensor.

8. An apparatus for electrical power storage, the apparatus comprising
an enclosure which comprises a terminal of a battery pack and an electrical disconnect mechanism, which is connected to a water sensor that is external to the enclosure
said enclosure having an electrical contact on the exterior of the enclosure which is electrically conductively connected to said battery pack terminal such that power can flow to the battery pack from the exterior contact and from the exterior contact to the battery pack
said electrical disconnect mechanism configured to electrically disconnect the terminal from the external contact when water is detected by the water sensor.

9. An electrical power storage unit according to claim 8 such that the battery pack terminal is electrically isolated from anything external to the enclosure when the electrical disconnect mechanism is activated.

10. An auxiliary circuit breaker comprising
an enclosure which comprises a primary electrical branch, having a switch, that electrically conductively connects an input and an output terminal, and a secondary branch that electrically conductively connects said output terminal of the primary circuit to a water sensor wherein the switch in the primary circuit is automatically opened when the water sensor causes current to flow in the secondary circuit as a result of immersion in water such that the input terminal of the primary branch is electrically separated from the output terminal.
